(19) United States
(12) Patent Application Publication
(10) Pub. No.: US 2008/0115948 A1
(43) Pub. Date: May 22, 2008

(54) Sprinkler Head

(76) Inventor: Yasuaki Koiwa, Iwate (JP)

Correspondence Address: WENDEROTH, LIND & PONACK, L.L.P., 2033 K STREET N. W., SUITE 800, WASHINGTON, DC, 20006-1021, US

(21) Appl. No.: 11/795,841

(22) PCT Filed: May 10, 2005
(86) PCT No.: PCT/JP05/08481

§ 371 Date: Jul. 23, 2007

(51) Int. Cl. A62C 37/08

(52) U.S. Cl. 169/38; 169/37; 169/41

(57) ABSTRACT

[Problems]

To provide a sprinkler head installed by burying it in a ceiling, having a cover plate to conceal the sprinkler head, enabling the adjustment of the height of the sprinkler head relative to the surface of the ceiling, and capable of efficiently transferring the heat of flame absorbed by the cover plate to the heat sensitive body of the sprinkler head.

[Means for Solving Problems]

A heat collector (15) having a plurality of fins (14) in the radial direction is fitted to the heat sensitive body of the sprinkler head, and the fins (14) are bent in a diagonal lower side by a plurality of bent parts (16). A disk-like heat collector (13) is stackingly installed on the upper part of the heat collector (15), and ribs (13A) and (13B) formed on the heat collector (13) are installed at positions where the bent parts (16) are not interfered with the ribs (13A) and (13B) when the heat collector (15) is contracted.

### TECHNICAL FIELD

The present invention relates to a sprinkler head installed in a building, and is actuated in case of fire to spread fire-extinguishing water, and particularly to a sprinkler head installed as it is, embedded inside a ceiling, with a cover plate being installed for covering the same sprinkler head.

### BACKGROUND ART

A sprinkler head installed in a ceiling or a wall of a building interior is coupled to water supply piping, and a nozzle therein is closed by a valve provided within the sprinkler head. The valve is supported by a heat-sensitive operating section where a heat-sensitive element is incorporated, and in operation, the heat-sensitive element senses the heat from fire and actuates the heat-sensitive operating section to open the valve.

When the valve is open, fire-extinguishing water within the nozzle is released, and the fire-extinguishing water impinges upon a deflector disposed ahead of the nozzle and spreads all around to mitigate or extinguish fire.

In view of a fact that a sprinkler head of the type as described above is not desirably furnished in a room from the viewpoint of design, there is provided one type of sprinkler head that has employed a cover plate for covering over the sprinkler head.

The cover plate is connected with a housing, which is mounted externally to the sprinkler head by use of a low melting point alloy. In case of fire, hot air stream from flames and smoke as well as heat absorbed by the cover plate melt the low melting point alloy to thereby disengage the cover plate from the housing and permit the cover plate to drop down.

Subsequent to the dropping-off of the cover plate, the sprinkler head disposed inside the housing is actuated by the heat from fire so as to spread the fire-extinguishing water around.

The sprinkler head covered with such a cover plate as described above includes, for example, one disclosed in the following Patent Document 1, which is shown in FIG. 6 in the drawings of the present invention.

The sprinkler head as shown in FIG. 6 comprises a spiral heat collector 30 with one end connected with a heat-sensitive element 29 and with the other end in contact with a cover plate 50. In case of fire, the cover plate 50 absorbs the heat from fire, and the heat absorbed by the cover plate 50 is transferred to the heat-sensitive element 29 via the heat collector 30 so as to cause the sprinkler head to be operated.

In addition, the above-describe sprinkler head is so designed that a plurality of horizontal grooves formed on an outer circumferential surface of a main body 10 are brought into engagement with layered protrusions 43 provided in an upper portion inside a casing 40 to adjust a variable level of the sprinkler head relative to the ceiling level, and in response to this adjustment, the heat collector 30 is expandable or contractible correspondingly.

### List of Patent Documents

Patent Document 1: Japanese Patent Laid-open Publication No. 2003-265642 (pp. 2-3, FIG. 1)

### DISCLOSURE OF THE INVENTION

### Problem to be Solved by the Invention

However, in the sprinkler head of the type described above, since the heat collector has a spiral configuration and consequently has a long path for the heat from fire to be transferred from the cover plate 50 to the heat-sensitive element 29, heat loss could be induced and the heat may not be efficiently transferred to the heat-sensitive element.

In the light of the above problem, an object of the present invention is to provide a sprinkler head that is installed as it is, embedded inside a ceiling, provided with a cover plate for covering over the sprinkler head, and including a means capable of adjusting a level of the sprinkler head relative to a ceiling level, in which a heat from fire absorbed by the cover plate can be transferred to a heat-sensitive element of the sprinkler head in an efficient manner.

### Means to Solve the Problem

To accomplish the object stated above, an invention as disclosed in claim 1 provides a sprinkler head that is installed as it is, embedded inside a ceiling, provided with a cover plate for covering over the sprinkler head, and includes a means capable of adjusting a level of the sprinkler head relative to a ceiling level, in which a heat collector having a plurality of radially extending fins is disposed in a heat-sensitive element of the sprinkler head, each of the fins being bent by a plurality of bends so as to extend obliquely downwardly and be expandable and contractible elastically.

An invention as disclosed in claim 2 provides a sprinkler head as defined above, in which another heat collector of plate configuration is disposed above said heat collector defined in claim 1.

An invention as disclosed in claim 3 provides a sprinkler head as defined in claim 2, in which said heat collector of plate configuration is provided with a rib, the rib is disposed at such a location that when the heat collector as defined in claim 1 contracts, the bends would not interfere with the rib.

### Effect of the Invention

According to the invention defined in claim 1, the heat collector attached to the heat-sensitive element of the sprinkler head has employed such a configuration that a plurality of radially extending fins are suspended obliquely and downwardly. Therefore even when the level of the sprinkler head relative to the ceiling level has changed, tip portions of the fins are constantly kept in contact with the cover plate so as to allow the heat to be transferred from the cover plate to the heat-sensitive element.

In addition, by employing a radially extending arrangement for the heat collector, the path of the heat transfer from the cover plate to the heat-sensitive element has been successfully reduced over the conventional arrangement, so that the heat can be transferred to the heat-sensitive element efficiently.

Incidentally, in the configuration of the sprinkler head of the present invention, the cover plate is fitted around an outer circumferential portion of the sprinkler head after the sprinkler head has been connected to a water supply piping. Accordingly, when the cover plate is fitted around the sprinkler head, since the bends are formed in the fins, the fins are deformed so that they are expanded with those bends working as supporting points.

Further, since a plurality of bends is defined in each of the fins, when a force is applied to the fins from beneath, the fins are urged to spread outward while sliding along on an inner surface of the cover plate without fail, so that the tip ends of the fins are prevented from being caught by the cover plate and resultantly deformed thereby.

In addition, since each of the bends has experienced a work hardening, they effectively contribute to an increased rigidity of the entire fins.

According to the invention defined in claim 2, since the heat collector of plate configuration is disposed in the upper portion of the sprinkler head, it allows more heat from fire to be transferred to the heat-sensitive element after the cover plate has dropped off, which enables the sprinkler head to be actuated more quickly.

According to the invention defined in claim 3, since the rib is formed in the heat collector of plate configuration, it can effectively enhance the rigidity of the heat collector, and since the rib is positioned at such a location that the rib would not interfere with the bends of the fins, it can effectively prevent any stress concentration from occurring on the bends.

### PREFERRED EMBODIMENTS FOR CARRYING OUT THE INVENTION

A first embodiment of the present invention will now be described with reference to FIGS. 1 through 5. FIG. 1 represents a sectional view of a sprinkler head of the present invention; FIG. 2 represents an enlarged view of main components in a heat collector region of FIG. 1; FIG. 3 represents a sectional view of the heat collector when it is contracted; FIG. 4 represents a view similar to FIG. 1, but where a cover plate has dropped off; and FIG. 5 shows the sprinkler head of FIG. 1, when it is actuated to spread water around, respectively.

The sprinkler head shown in FIG. 1 comprises a main body 1, a heat-sensitive decomposition system 2, a heat collecting system 3, a housing 4 and a cover plate 5.

The main body 1 is connected with a water supply piping via a male thread 6 provided in an outer surface of the main body 1 and has in an interior thereof a nozzle 8 sealed with a valve element 7. The valve element 7 is always under a force applied from the heat-sensitive decomposition system 2 toward the direction for closing the nozzle 8, and in operation, the valve 7 can be opened via the heat-sensitive decomposition system 2, as it is decomposed due to a heat from fire, for releasing fire-extinguishing water from the nozzle 8.

The heat-sensitive decomposition system 2 provides a feature that is decomposed by heat as explained above, and may include, by way of example, the one disclosed in Japanese Patent Publication No. S58-3698. Since the heat-sensitive decomposition system 2 is well known, a detailed description thereof will be herein omitted. A cylinder 10 is disposed in a lower end of the heat-sensitive decomposition system 2, which is loaded with a low-melting point alloy 9 serving as a heat-sensitive element inside the cylinder.

A plunger 11 is mounted on the low-melting point alloy 9 loaded inside the cylinder 10, and a force compressing the low-melting alloy 9 is provided from the heat-sensitive decomposition system 2 via the plunger 11. In operation of the sprinkler head with this configuration, as the low-melting point alloy 9 is fused from the heat from fire, the plunger 11 sinks down into the cylinder 10, which effects the decomposing process to actuate the heat-sensitive decomposition system 2.

The lower end of the cylinder 10 is connected with the heat collecting system 3 which comprises heat collectors 12 and 13 of disk configuration and a heat collector 15 having a plurality of fins 14 extending radially, which are as a whole serving as the heat collecting system 3. The heat collecting system 3 serves to transfer the heat from fire to the low-melting alloy 9 within the cylinder 10. Preferably, any suitable number and size of the heat collector 12, 13 to be disposed may be selected and used by taking a scale of the building as well as a volume of flammable items into account.

The heat collector 15 disposed at the lowest position is adapted to deform through a sliding motion of the fins 14 with their tip moving along on an inner surface of the cover plate 5 in dependence with the level of the sprinkler head relative to the ceiling level and is caused to deform always outward with the aid of a plurality of bends 16 provided in each of the fins 14.

This keeps the constant contact of the tip ends of the fins 14 with the cover plate 5, and thereby helps to achieve reliable transfer of the heat absorbed by the cover plate 5 to the low-melting point alloy 9. In addition, the provision of the plurality of bends 16, which have experienced the effect of work hardening, can contribute to an increased rigidity of the fins 14.

A plurality of annular ribs 13A and 13B is formed in the heat collector 13. The ribs 13A and 13B effectively function to prevent the deformation of the heat collector of thin plate configuration. The ribs 13A and 13B are arranged in such a position that when the heat collector 15 contracts as shown in FIG. 3, the bends 16 are prohibited from coming into contact with the ribs of the heat collector 13, and thus a stress concentration on the bends 16 can be avoided.

Preferably, a material of the heat collector 12, 13 and 15 may comprise copper and copper alloys having higher heat conductivity. Further preferably, the heat collector 15 specifically uses such a material that has spring property in addition to higher heat conductivity.

The housing 4 has a cylindrical configuration and a collar 17 is formed in a lower end thereof. The housing 4 in an upper portion includes an engaging section with the main body 1, as previously described, and the engaging section has a pawl 18 protruding inwardly. The pawl 18 is engaged with a spiral groove carved in an outer circumferential surface of the sprinkler head.

A plurality of mounts 19 for connection with the cover plate 5 is disposed in the collar 17, and lower ends of the mounts 19 are connected to the cover plate 5 by use of a low-melting point alloy 21. Preferably, the low-melting point alloy 21 having its melting point lower than that of the low-melting point alloy 9 used in the sprinkler head may be employed.

The cover plate 5 has a curved surface profile and is connected with the housing 4 via the low-melting point alloy 21 and the mount 19, as previously described. Preferably, the cover plate 5, in order to facilitate the fusing of the low-melting point alloy 9 used in the sprinkler head in addition to provide a function to cover over the sprinkler head, may comprise a material similar to that of the above-discussed heat collector 12, 13, so that it can absorb the heat from fire efficiently.

Although the cover plate 5 has the curved surface profile in the illustrated embodiment, the cover plate having a flat surface profile may be employed.

A procedure for installing a sprinkler head of the present invention will now be described.

It is contemplated with the sprinkler head of the present invention that the housing 4 is fitted with the main body 1 after the main body 1 has been installed in connection with the water supply piping, and accordingly in the procedure, first of all, the male thread 6 is connected with the water supply piping. In this condition, the heat collecting system 3 of the sprinkler head is seen from the lower surface side of the ceiling.

Subsequently, the housing 4 is inserted from the lower surface side of the ceiling and pushed over the lower end of the sprinkler head into a position sufficient for the cover plate 5 to come in contact with the lower surface of the ceiling. This brings the pawl 18 of the housing 4 into engagement with the spiral groove carved in the outer circumferential surface of the sprinkler head, while at the same time urging the fins 14 of the heat collector 15 to spread outward with the tip ends of the fins 14 in contact with the cover plate 5 and thus to deform with the tip ends sliding along on the inner surface of the cover plate 5.

The housing 4 can be installed in the sprinkler head 1 in accordance with the steps of the above-described procedure.

An operation of the sprinkler head of the present invention will now be described.

The sprinkler head of the present invention is installed as it is, embedded in the ceiling, as shown in FIG. 1, and has a cover plate 5 disposed at substantially the same level as the lower surface of the ceiling, so that the components, such as the main body 1 and the heat collecting system 3, are hidden from sight.

When a fire occurs, as hot air stream from flames and smoke drifts below the lower surface of the ceiling, the cover plate 5 absorbs the heat from the hot air stream. The heat absorbed by the cover plate 5 facilitates the fusing of the low-melting point alloy 21 serving for the connection of the mounts 19, while at the same time being transferred to the low-melting point alloy 9 within the cylinder 10 via the heat collector 15 placed in contact with the cover plate 5.

The heat absorbed by the cover plate 5 fuses the low-melting point alloy 21 serving for the connection between the cover plate 5 and the mount 19 and permits the cover plate 5 to drop off, as shown in FIG. 4. As the cover plate 5 has dropped off, the sprinkler head within the housing 4 becomes exposed. The heat collector 15 returns to its original configuration owing to its own elasticity, where it is suspended with its tip end heading downward, and the fins 14 of the heat collector 15 are positioned as they are protruding beyond the under surface of the ceiling.

The fins 14 absorb the heat from the hot air stream drifting below the lower surface of the ceiling and transfer that heat to the low-melting point alloy 9 loaded inside the cylinder 10. In addition, since the cover plate 5 has been dropped off, favorably, the heat collectors 12 and 13 also can absorb more heat from the hot air stream. The heat absorbed by the fins 14 and the heat collectors 12 and 13 is transferred to the cylinder 10, where the low-melting point alloy 9 loaded inside the cylinder 10 is fused by the heat which allows the plunger 11 to sink down into the cylinder 10, which in turn effects the decomposing process for actuating the heat-sensitive decomposition system 2.

The valve element 7 is now open due to the decomposition and actuation of the heat-sensitive decomposition system 2 that has previously held the valve element 7, so that the nozzle 8 can release a fire extinguishing water from the water supply piping. The releasing of the fire extinguishing water displaces a deflector D, previously accommodated inside the sprinkler head into a position, where it protrudes ahead of the nozzle 8. The extinguishing water released from the nozzle 8 impinges upon the deflector D to spread in all directions to thereby-mitigate or extinguish fire with the fire extinguishing water being dispersed around.

### BRIEF DESCRIPTION OF THE DRAWINGS

FIG. 1 is a sectional view of a sprinkler head of the present invention;

FIG. 2 is an enlarged view of main components in a heat collector region of FIG. 1;

FIG. 3 is a sectional view of a heat collector, where the heat collector has contracted;

FIG. 4 shows a view similar to FIG. 1, but where a cover plate has dropped off;

FIG. 5 shows the sprinkler head of FIG. 1, when it has been actuated to spread water around; and

FIG. 6 is a sectional view of a sprinkler head as disclosed in the cited Patent Document 1.

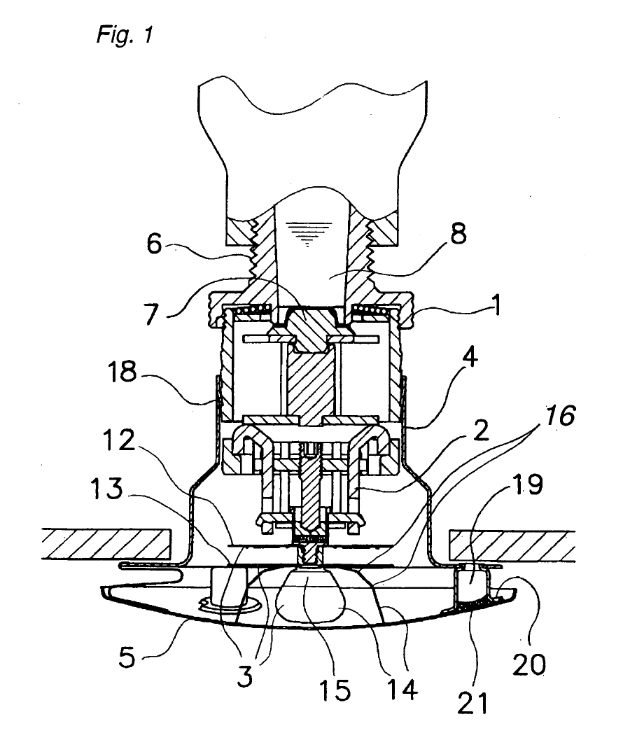

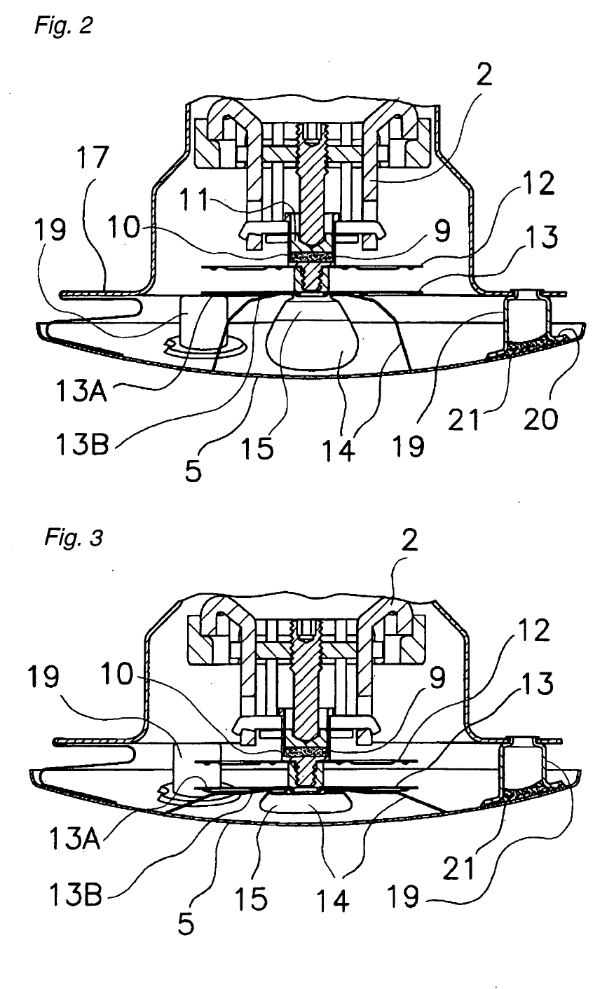

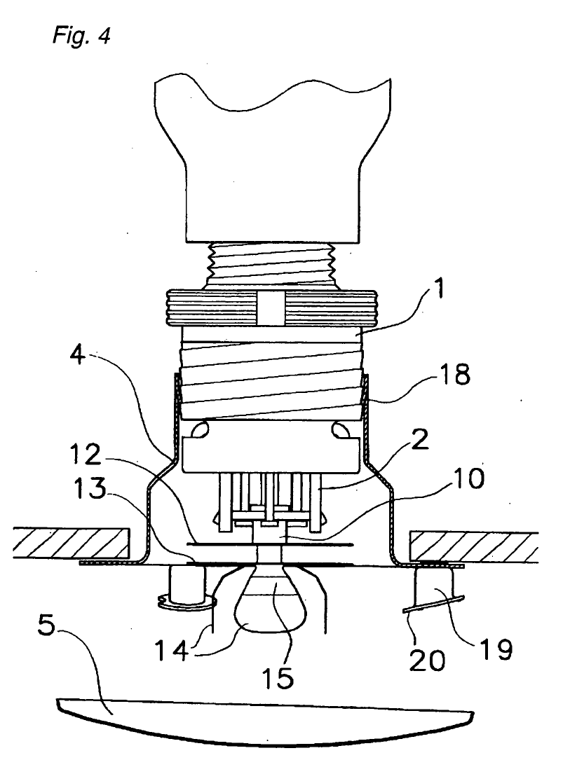

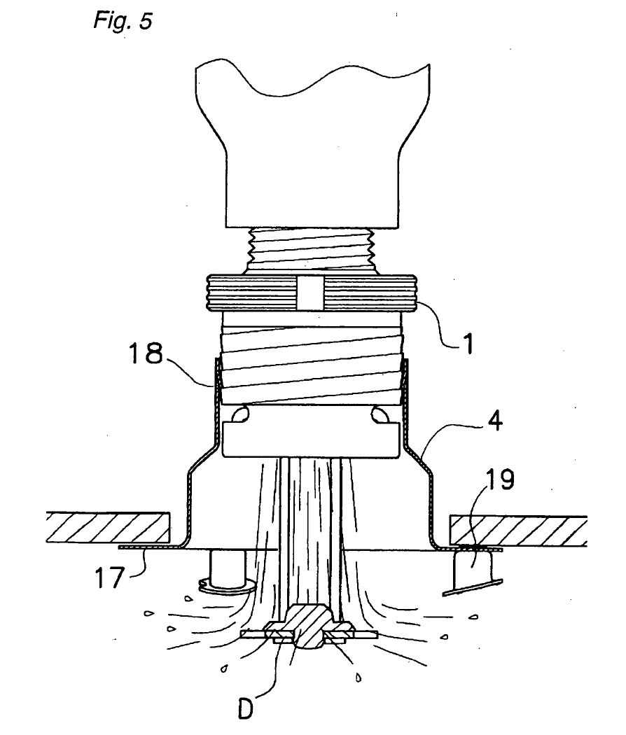

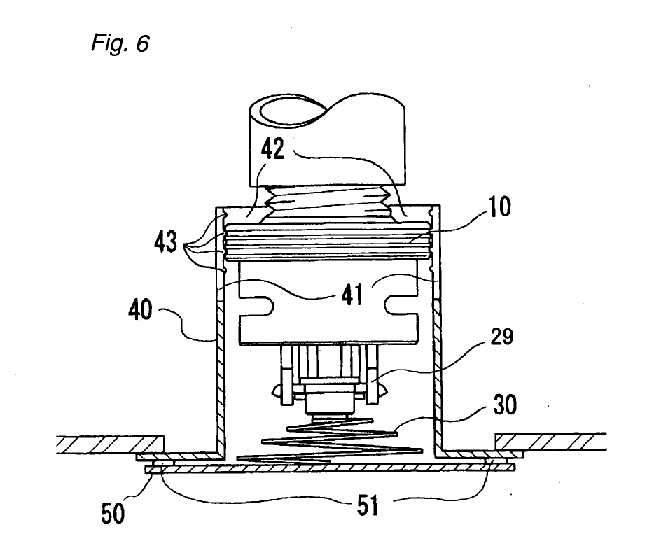

### DESCRIPTION OF REFERENCE NUMERALS

1 Main body

2 Heat-sensitive decomposition system

3 Heat collecting system

4 Housing

5 Cover plate

9, 21 Low melting point alloy

10 Cylinder

11 Plunger

12, 13 Heat collector of disk configuration

14 Fin

15 Heat collector

16 Bends

17 Collar

19 Mount

1. A sprinkler head that is installed as it is, embedded inside a ceiling, provided with a cover plate for covering over said sprinkler head, and including a means capable of adjusting a level of said sprinkler head relative to a ceiling level, said sprinkler head characterized in that:
a heat collector having a plurality of fins extending radially is disposed in a heat-sensitive element of said sprinkler head, each of said fins being bent by a plurality of bends so as to extend obliquely downwardly and is expandable and contractible elastically.

2. A sprinkler head in accordance with claim 1, in which another heat collector of plate configuration is disposed above said heat collector.

3. A sprinkler head in accordance with claim 2, in which said another heat collector of plate configuration is provided with a rib, said rib is disposed at such a location that when said heat collector contracts, said bends do not interfere with said rib.
